(19) United States
(12) Patent Application Publication
(10) Pub. No.: US 2006/0224893 A1
(43) Pub. Date: Oct. 5, 2006

(54) Secure wireless communication apparatus and method for electronic devices incorporating pushed pins

(75) Inventors: Randall W. Sales, Everett, WA (US); Daniel Dean, Snohomish, WA (US); Joseph J. Kubler, Boulder, CO (US)

Correspondence Address: BRIAN M BERLINER, ESQ;O'MELVENY & MYERS, LLP, 400 SOUTH HOPE STREET, LOS ANGELES, CA, 90071-2899, US

(73) Assignee: INTERMEC IP CORP.

(21) Appl. No.: 11/098,914

(22) Filed: Apr. 4, 2005

(51) Int. Cl. H04L 9/00

(52) U.S. Cl. 713/171

(57) ABSTRACT

A secure wireless communications connection, such as a secure communications connection using the Bluetooth communications standard, may be established between two electronic devices without requiring user input of a personal identification number and without transmitting a personal identification number such that the personal identification number may be easily intercepted. To establish a secure wireless communications connection between two electronic devices already communicating over a non-secure channel, the first device encrypts a personal identification number using a public key sent by the second device. The first device then transmits or pushes the encrypted personal identification number to the second device. The second device decrypts the personal identification number, and the two devices use the personal identification number to create a secure communications connection.

### BACKGROUND OF THE INVENTION

1. Field of the Invention

The present invention relates to data transmissions among electronic devices and more particularly to securing a wireless communications connection between multiple electronic devices.

2. Description of Related Art

Various wireless communications protocols such as Bluetooth provide standards for wireless communication links between electronic devices such as cellular telephones, portable digital assistants, and mobile computers. The number and types of electronic devices with wireless communications capabilities are dramatically growing. Focusing specifically on the recent proliferation in number and types of Bluetooth-enabled devices, Bluetooth wireless communications capabilities can be found in devices as diverse as automobiles and medical devices as well as the more expected complement of cellular telephones, portable digital assistants and the like. In many instances, users of electronic devices desire a secure wireless communications connection so that information wirelessly transmitted from one electronic device to another is protected against eavesdropping. Such an encrypted connection is highly desired when transferring sensitive meeting notes, medical records, or a user's personal data from a PDA to a mobile computer or sharing sensitive files among a group of wirelessly communicating electronic devices.

Under the prior art methods, securing a Bluetooth connection with encryption generally required registration of a specific Personal Identification Number (PIN) on all devices wishing to make use of the secure connection. The PIN registration process has typically been implemented as a manual process requiring entry of the PIN on each of the devices between which secure communication is desired. The prior art manual PIN entry process has significant drawbacks: it is cumbersome, time consuming, and prone to data entry error. Further, manual PIN entry is nearly impossible on Bluetooth-enabled devices that do not provide a User Interface (UI) for PIN entry.

An alternative to manual PIN entry for PIN registration among electronic devices is to employ an existing (non-secure) wireless connection to transmit a PIN between the electronic devices for which a secure connection is desired. This PIN transmission alternative alleviates the cumbersome nature of manual PIN entry and its accompanying potential for PIN entry error. But, transmitting a PIN over a non-secure wireless communications connection creates substantial security concerns that undermine the benefits of encrypted communication. Notably, the transmission of a PIN over a non-secure wireless connection may be intercepted by a third party who can then use the intercepted PIN. This interceptor can then eavesdrop on any subsequent communications on what is perceived to be a secure communication connection.

Therefore, based on the shortcomings of the prior art discussed above, there is a need in the art for an apparatus and method to create a secure wireless communications link that allows sharing of PINs without requiring manual entry of the PINs, that allows sharing PINs even for devices that do not have a UI, and that limits access of spying third parties to the shared PINs.

### SUMMARY OF THE INVENTION

The present invention addresses the shortcomings of the prior art and provides an apparatus and method for establishing a secure wireless communications link between two wireless communications-enabled devices. In the apparatus and method of the present invention, one wireless communication-enabled device will transmit or push an encrypted communication of a generated PIN value to another electronic device across a previously existing (non-secure) wireless communications connection. Subsequent communications between the electronic devices are secure, as each device enters a secure communications mode using the shared PIN. Using the apparatus or method of the present invention, no cumbersome, error-prone manual PIN entry is required. Further, the present invention may be used to push a PIN to an electronic device that does not have a UI for entering PINs, thereby facilitating secure communications with these electronic devices. Additionally, since the PIN is encrypted for its transmission over a wireless communications connection, the risk of a third party being able to use the PIN to spy on subsequent secure communications is greatly reduced as compared with the prior art PIN transmission method.

A more complete understanding of the secure wireless communication apparatus and method will be afforded to those skilled in the art, as well as a realization of additional advantages and objects thereof, by a consideration of the following detailed description of a preferred embodiment of the invention. Reference will be made to the appended sheets of drawings, which will be first described briefly.

### BRIEF DESCRIPTION OF THE DRAWINGS

FIG. 1 is a block diagram depicting the apparatus of the present invention.

FIG. 2 is a flow chart showing the steps to establish a secure wireless communications connection according to a method of the present invention.

FIG. 3A is a graphic icon depiction of the establishment of a non-secure communications connection between two electronic devices.

FIG. 3B is a graphic icon depiction of the transmission of a go to secure mode command over a non-secure communications connection between two electronic devices.

FIG. 3C is a graphic icon depiction of the transmission of a public key from one electronic device to another electronic device over a non-secure communications connection.

FIG. 3D is a graphic icon depiction of the transmission of an encrypted PIN from one electronic device to another electronic device over a non-secure communications connection.

FIG. 3E is a graphic icon depiction of the transmission of a data file over a secure communications connection.

### DETAILED DESCRIPTION OF THE PREFERRED EMBODIMENT

The present invention provides an apparatus and method for achieving a secure wireless communications connection between electronic devices that overcomes the limitations of the prior art. In the detailed description that follows, like element numerals are used to indicate like elements that appear in one or more of the drawings.

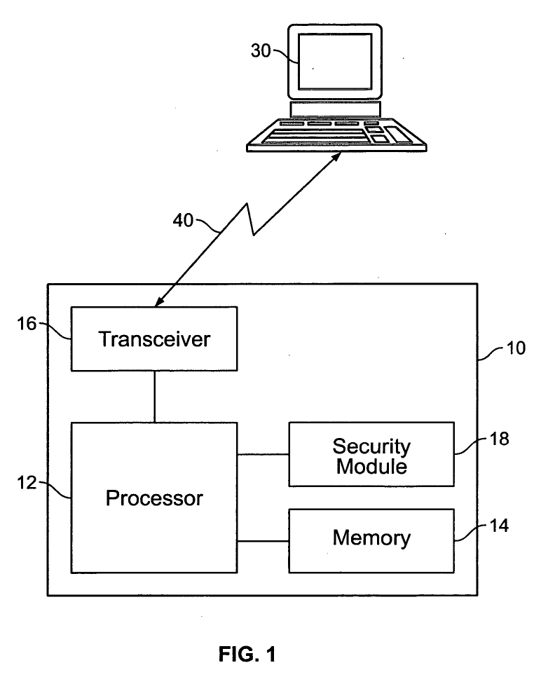

FIG. 1 depicts the apparatus of the present invention in block diagram format. The apparatus comprises a first electronic device 10 further comprising a processor 12, a memory 14 operatively connected to the processor 12, a transceiver 16 operatively connected to the processor 12 and configured to wirelessly communicate with a second electronic device 30, and a security module 18 configured to be executed by the processor 12 to initiate a secure communications connection with the second electronic device 30. The first and second electronic devices 10, 30 may be any two electronic devices able to communicate wirelessly. Preferably, the first and second electronic devices 10, 30 are Bluetooth-enabled devices that wirelessly communicate using the Bluetooth communications protocol. The Bluetooth protocol is promoted by the Bluetooth Special Interest Group. Bluetooth is an open specification technology, whose specifications can be obtained from Bluetooth SIG, Inc. or downloaded from the following URL address: http://www.Bluetooth.org.

The memory 14 of the first electronic device 10 is configured to store an encryption key and a personal identification number. The stored encryption key and personal identification number would then be used by the security module 18 when initiating a secure communications connection. The encryption key is generated by the second electronic device 30 and wirelessly transmitted to the transceiver 16 of the first electronic device 10. The second electronic device 30 also generates a corresponding decryption key which is retained in a memory of the second electronic device 30. Preferably, the encryption key comprises a public key and the corresponding decryption key comprises a private key, each generated by the second electronic device 30 according to a public key encryption technique.

The transceiver 16 of the first electronic device 10 is operatively connected to the processor 12 and is configured to communicate wirelessly with a second electronic device 30 over a wireless communications connection 40. Preferably, the transceiver 16 is configured to communicate wirelessly using the Bluetooth communications protocol.

The security module 18 of the first electronic device 10 is executable by the processor 12, and is configured to initiate a secure communications connection with the second electronic device 30. The security module 18 initiates the secure communications connection with the second electronic device by using the transceiver 16 to transmit a personal identification number encrypted according to the encryption key stored in the memory 14 of the first electronic device 10. Advantageously, since only an electronic device possessing the corresponding decryption key will be able to easily decode the personal identification number, it would be difficult for an eavesdropping device to obtain the personal identification number and subsequently join the secure communications connection. The security module 18 may initiate the secure communications connection with the second electronic device 30 by initially using the transceiver 16 to send a command to the second electronic device 30 requesting an encrypted connection. This command requesting an encrypted connection may be triggered by a trigger event such as a request to send a certain type of data or a file of a certain type. Or, the command requesting an encrypted connection may be sent upon the initiation of a non-secure communications channel between the first electronic device 10 and the second electronic device 30.

In the apparatus of the present invention, neither the first electronic device 10 nor the second electronic device 30 requires a user interface for the security module 18 to to initiate a secure communications connection. Therefore, the apparatus of the present invention facilitates secure wireless communications using shared personal identification numbers even among electronic devices that do not have keypads or other convenient data entry devices. Additionally, since no user interface is required for the security module 18 to initiate a secure communication connection, the apparatus of the present invention advantageously avoids the cumbersome and error-prone nature of manual PIN entry.

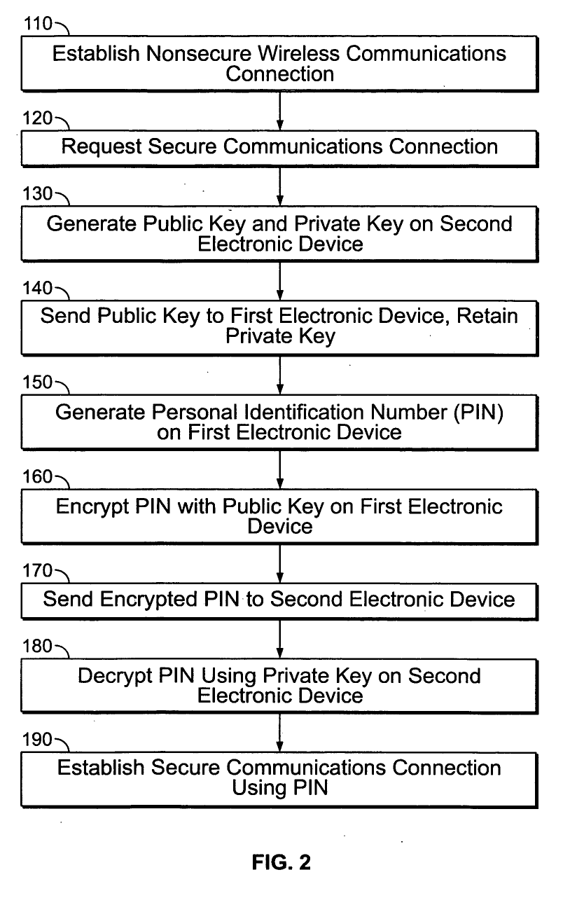

The present invention also comprises a method for two wirelessly-communicating electronic devices to establish a secure communications link by securely sharing a personal identification number. FIG. 2 depicts the steps of the method of the present invention in flow chart format. A brief overview of the steps, as depicted in FIG. 2, follows. In step 110, a non-secure wireless communications connection between a first electronic device and a second electronic device is established. In step 120, the first electronic device sends a command requesting an encrypted connection to the second electronic device over the non-secure communications connection. In step 130, the second electronic device generates an encryption key and a decryption key. In step 140, the second electronic device transmits the encryption key to the first electronic device over the non-secure communications connection, and retains the decryption key. In step 150, the first electronic device generates a personal identification number. In step 160, the first electronic device encrypts the personal identification number using the public key sent from the second electronic device. In step 170, the first electronic device sends the encrypted personal identification number to the second electronic device over the non-secure communications connection. In step 180, the second electronic device decrypts the personal identification number using the private key. In step 190, the first and second electronic devices use the personal identification number to establish a secure wireless communications connection.

The non-secure wireless communications connection in step 110 is preferably a communications connection employing the Bluetooth wireless communications protocol between Bluetooth-enabled devices. The method of the present invention is not limited to a type or types of Bluetooth-enabled device. Rather, the method may be performed by substantially all currently-existing Bluetooth-enabled electronic devices. Alternately, the method of the present invention may be performed by electronic devices communicatively connected using another wireless communications protocol.

The sending of a command to request an encrypted connection by the first electronic device in step 120 may be triggered by the occurrence of a certain event such as a request to transfer a predetermined type of sensitive data or a predetermined file type between electronic devices. Alternately, the sending of this command in step 120 may be triggered by user input on the first or the second electronic device. Still another possibility to trigger the sending of the command in step 120 is that the command is automatically sent whenever the first and second electronic devices establish a non-secure wireless communications connection (i.e. attempting to achieve a secure communications connection is a default communications mode).

Once the second electronic device receives the command requesting an encrypted connection, the second electronic device generates an encryption/decryption key set in step 130. Preferably, the encryption key comprises a public key and the decryption key comprises a private key generated according to a public key encryption technique. Various methods for public key encryption known in the art may be employed to generate this key set in step 130. In step 140, the public key is sent from the second electronic device to the first electronic device. The second electronic device retains the private key so that the first electronic device may then transmit messages encrypted using the public key that can be decrypted and read by the second electronic device with the private key.

The generation of personal identification numbers by the first electronic device, depicted as step 150, may be conducted by any of a variety of techniques known in the art. For example, personal identification numbers may be randomly generated according to a pseudo random number generation technique known in the art. Random generation of personal identification numbers would limit spying on securely transmitted data by an eavesdropping electronic device as it would be highly unlikely that the eavesdropping electronic device would be able to correctly predict a randomly generated PIN. Alternately, personal identification numbers may be generated according to an automated personal identification number rotation system.

In step 160, the first electronic device employs the public key sent in step 140 to encrypt the personal identification number generated in step 150. In step 170, the first electronic device transmits the encrypted personal identification number to the second electronic device over the non-secure wireless communications connection. Unlike the prior art nonencrypted PIN transmissions, the PIN transmission of the present invention can only be decrypted and read by an electronic device having the private key corresponding to the public key used to encrypt the PIN. Thus, advantageously, it is unlikely that an eavesdropping electronic device would be able to intercept and use the encrypted PIN transmission of the present invention.

In step 180, the second electronic device decrypts the encrypted personal identification number using the private key. In step 190, the first and second electronic devices use the personal identification number to establish a secure wireless communications connection according to a technique known in the art. For example, the Bluetooth communication protocol sets forth a series of authorization communications to establish a secure wireless communications connection when a common PIN has been registered on two communicating electronic devices.

Advantageously, the method of the present invention may be performed without requiring user input on either of the electronic devices. The method of the present invention could be completely software or firmware implemented such that once a command requesting an encrypted communication has been sent in step 120, the other steps of the method proceed substantially automatically. Where the present invention is implemented as a substantially automatic method, the present invention facilitates the establishment of a secure wireless connection where one or both of the electronic devices do not have a user interface allowing manual PIN entry. Alternately, the method of the present invention could require user input for an electronic device to perform one or more of the steps of the method. In this alternate embodiment, one or both of the electric devices could prompt the user for input before performing one or more of the steps of the method. For example, user input could be requested by the second electronic device after receiving the command requesting an encrypted communications connection sent in step 120. In response to such a prompt, the user of the second electronic device could elect not to proceed with establishing a secure connection.

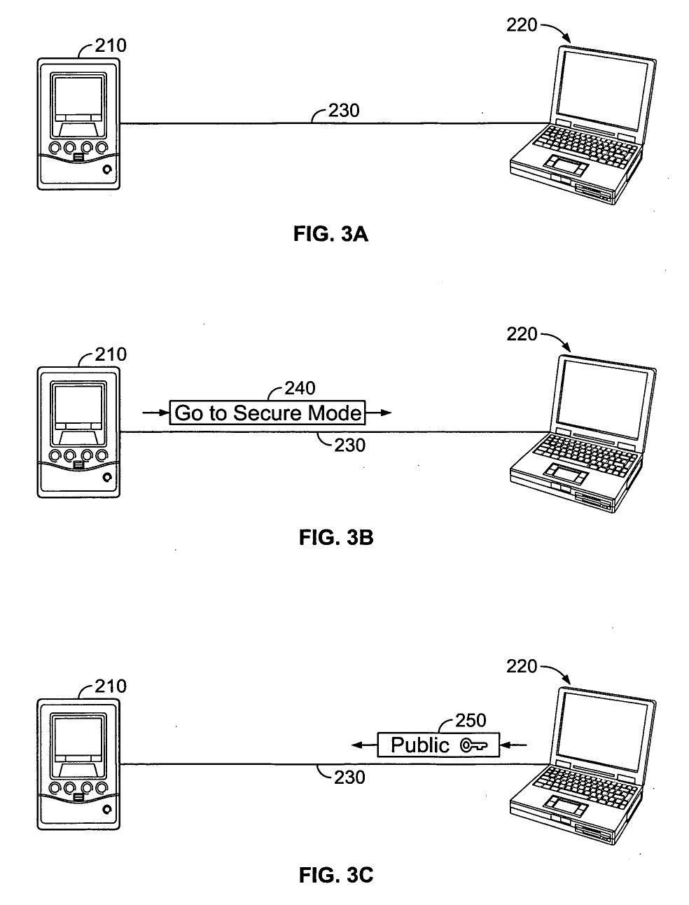

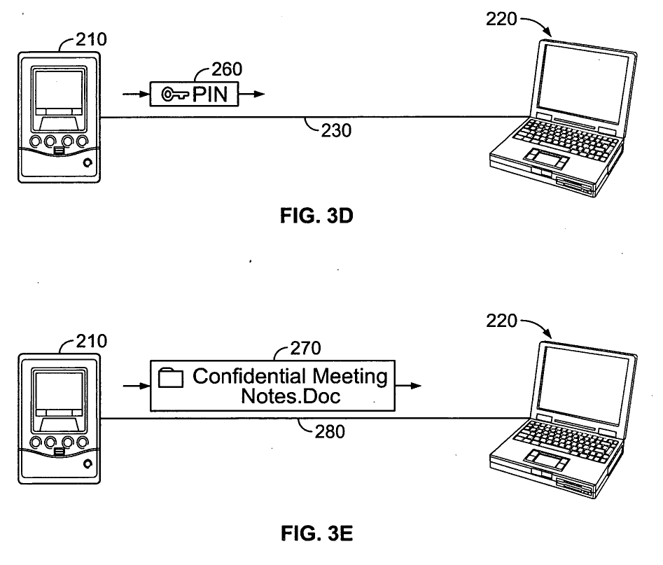

FIG. 3 depicts the steps of the method of the present invention in a graphical format. FIG. 3A depicts a first electronic device 210 and a second electronic device 220 communicatively connected with an established non-secure wireless communications connection 230. FIG. 3B depicts the first electronic device 210 sending a command 240 to the second electronic device 220 over the non-secure wireless communications connection 230, the command 240 requesting an encrypted connection. In response to the command 240, the second electronic device 220 would generate an encryption/decryption keyset comprised of a public encryption key and a corresponding private decryption key. FIG. 3C depicts the second electronic device 220 sending the public key 250 to the first electronic device 210 over the non-secure wireless communications connection 230. The second electronic device 220 retains the corresponding private key. The first electronic device 210 generates a personal identification number and, upon receipt of the public key 250, encrypts the personal identification number with the public key. FIG. 3D depicts the first electronic device 210 sending the personal identification number 260 that has been encrypted using the public key 250 to the second electronic device 220. After receiving the encrypted personal identification number 260, the second electronic device 220 decrypts the personal identification number 260 using the private key corresponding to the public key 250. Once the personal identification number 260 has been decrypted by the second electronic device 220, it is used by the devices to establish a secure wireless communications connection. Once the secure wireless communications connection has been established, the electronic devices may securely exchange data. FIG. 3E depicts the first electronic device 210 and the second electronic device 220 exchanging a data file 270 over a secure wireless communications connection 280 that was created by using the personal identification number 260.

Having thus described several embodiments of the wireless communications method, it should be apparent to those skilled in the art that certain advantages of the system have been achieved. It should also be appreciated that various modifications, adaptations, and alternative embodiments thereof may be made within the scope and spirit of the present invention.

What is claimed is:

1. An electronic device further comprising:
a processor;
a memory operatively coupled to the processor and configured to store an encryption key and a personal identification number;
a transceiver operatively coupled to the processor and adapted to wirelessly communicate with a second electronic device; and
a security module executable by the processor and configured to wirelessly receive said encryption key from the second electronic device, encrypt said personal identification number using said stored encryption key, and initiate a secure wireless communications connection with the second electronic device by wirelessly transmitting said encrypted personal identification number to the second electronic device.

2. The electronic device of claim 1, wherein the encryption key stored in the memory has a corresponding decryption key that remains with the second electronic device.

3. The electronic device of claim 2, wherein the encryption key comprises a public key and the decryption key comprises a private key, and wherein the encryption key and the decryption key are generated by the second electronic device according to a public key encryption technique.

4. The electronic device of claim 1, wherein the transceiver is adapted to communicate with the second electronic devices in accordance with the Bluetooth wireless communications protocol.

5. The electronic device of claim 1, wherein the security module is further configured to wirelessly communicate to the second electronic device a command requesting a secure communications connection.

6. The electronic device of claim 5, wherein the security module is configured to transmit the command requesting a secure communications connection responsive to a trigger event.

7. The electronic device of claim 6, wherein the trigger event comprises a request to communicate a predetermined type of data to the second electronic device.

8. The electronic device of claim 6, wherein the trigger event comprises a request to communicate a predetermined file type to the second electronic device.

9. The electronic device of claim 6, wherein the trigger event comprises the establishment of a non-secure communications connection with the second electronic device.

10. A method for communicating between a first electronic device and a second electronic device, the method comprising the steps of:
generating an encryption key and a decryption key on the second electronic device;
sending the encryption key to the first electronic device over a non-secure wireless communications connection;
encrypting a personal identification number on the first electronic device using the encryption key;
sending the encrypted personal identification number to the second electronic device over the non-secure wireless communications connection;
decrypting the personal identification number on the second electronic device using the decryption key; and
establishing a secure wireless communications connection between the first electronic device and the second electronic device using the personal identification number.

11. The method of claim 10, further comprising the step of establishing the non-secure wireless communications connection between the first electronic device and the second electronic device.

12. The method of claim 11, wherein the non-secure wireless communications connection comprises a wireless communications connection using the Bluetooth communications protocol.

13. The method of claim 10, further comprising the step of sending a command from the first electronic device to the second electronic device over the non-secure communications connection, said command requesting an encrypted connection.

14. The method of claim 13, wherein the step of sending a command requesting an encrypted connection is responsive to a trigger event.

15. The method of claim 14, wherein the trigger event includes a request to transfer a predetermined type of data.

16. The method of claim 14, wherein the trigger event includes a request to transfer a predetermined file type.

17. The method of claim 14, wherein the trigger event includes the establishment of a non-secure communications connection between the first electronic device and the second electronic device.

18. The method of claim 12, further comprising the step of generating a personal identification number on the first electronic device.

19. The method of claim 18, wherein the step of generating a personal identification number on the first electronic device comprises randomly generating the personal identification number on the first electronic device.

20. The method of claim 18, wherein the step of generating a personal identification number on the first electronic device comprises generating a personal identification number on the first electronic device according to an automated personal identification number rotation system.

21. The method of claim 10, wherein the step of generating the encryption key and the decryption key is performed according to a public key encryption technique.

23. The method of claim 10, wherein all steps are performed without prompting a user for input.

24. The method of claim 10, further comprising the step of prompting a user for input prior to the step of establishing a secure wireless communications connection.
